(19) United States
(12) Patent Application Publication
(10) Pub. No.: US 2008/0041151 A1
(43) Pub. Date: Feb. 21, 2008

(54) Microfluidic device, in particular for metering a fluid or for the metered dispensing of a fluid, and method for producing a microfluidic device

(76) Inventors: Matthias Fuertsch, Gomaringen (DE); Stefan Finkbeiner, Gomaringen (DE); Christoph Schelling, Reutlingen (DE); Stefan Weiss, Tuebingen (DE); Thomas Wagner, Stuttgart (DE); Christian Maeurer, Leonberg (DE); Ines Breibach, Reutlingen (DE)

Correspondence Address: KENYON & KENYON LLP, ONE BROADWAY, NEW YORK, NY, 10004, US

(21) Appl. No.: 11/800,009

(22) Filed: Apr. 30, 2007

(30) Foreign Application Priority Data
May 24, 2006 (DE) 10 2006 024 286.6

(51) Int. Cl. G01F 1/68; B44C 1/22

(52) U.S. Cl. 73/204.16; 137/594; 216/41; 73/1.74; 73/204.11

(57) ABSTRACT

A microfluidic device for metering a fluid or for the metered dispensing of a fluid is provided, the device having a substrate, a pipette element having a dispensing side, which pipette element has a sealed side, and the device also having a heating device in the region of the sealed side. Alternatively, the microfluidic device is provided with the pipette element having a side that is connected to a reservoir, and a heating device in the region of the side connected to the reservoir.

### BACKGROUND OF THE INVENTION

1. Field of the Invention

The present invention relates to a microfluidic device for metering fluid dispensation.

2. Description of Related Art

Such a device is generally known e.g., the German laid-open document DE 102 02 996 describes a piezo-electrically controllable microfluidic actuator having a planar substrate, the microfluidic actuator having at least one cavity on at least one side, and at least one channel, the channel having an opening into the cavity; furthermore, at least one diaphragm is provided, which is affixed at the edge on one side of the substrate so as to span the cavity, the diaphragm being deflectable into the cavity by electrical control. Such a microfluidic actuator has the disadvantage of having a relatively complex structure, so that it is complicated to produce, which increases the manufacturing cost. Furthermore, such a microfluidic actuator does not allow the highly precise metering of very small fluid volumes as are used, for instance, to manipulate solutions such as reagents, analytica, test materials and the like in medical and biological applications. Furthermore, according to the related art it is disadvantageous that, due to the size of the known microfluidic actuators, it is impossible to combine or dispose a plurality of these microfluidic actuators in the form of a matrix in order to achieve a higher throughput rate in the implementation of processes that require the manipulation or metering of very small fluid volumes.

### BRIEF SUMMARY OF THE INVENTION

This microfluidic device according to the present invention and the method of the present invention for producing a microfluidic device have the advantage that the metering or dispensing of fluids is advantageously possible in a simple manner and with the aid of relatively uncomplicated and therefore cost-effective means; furthermore, it is possible to manipulate volumes that are in the picoliter range and below and, in addition, this manipulation of fluid volumes is advantageously implementable with relatively high precision.

According to a first example embodiment of the microfluidic device of the present invention, the device has a pipette element with a dispensing side, the pipette element having a sealed side, and the device having a heating device in the region of the sealed side, the pipette element having a side that is connected to a reservoir, and the device having a heating device in the region of the side connected to the reservoir. This example embodiment of the device according to the present invention has the advantage of providing a simple and robust actuating mechanism for the manipulation of fluid volumes, a special advantage being that no moveable components are involved.

According to an example embodiment of the microfluidic device of the present invention, the device has a pipette element having a volume of approximately 0.01 picoliter to approximately 10 picoliter, e.g., a volume of approximately 0.1 picoliter to approximately 1 picoliter. This allows an extremely precise metering of the fluid according to the present invention. For instance, according to the present invention it is possible to dispense a required total volume of the fluid located inside the pipette element by dispensing a certain number of partial volumes, so that the use of a device according to the present invention, which allows the dispensing of smaller volumes, makes it possible to achieve greater precision in the delivery of the overall volume.

According to an example embodiment of the microfluidic device of the present invention, the device has a pipette element having a diameter of approximately 0.5 μm to approximately 20 μm, e.g., approximately 1 μm to approximately 10 μm, and a wall thickness of the pipette element of approximately 10 nanometer to approximately 10 μm, approximately 100 nanometer to approximately 2 μm. Using simple means, the volume contained within the pipette element is able to be determined very accurately and the characteristic of the detaching of fluid droplets from the dispensing side of the pipette element influenced as well via the precise selection of the wall thickness of the pipette element.

According to the present invention, the features of the different example embodiments of the microfluidic device are able to be combined with each as desired.

According to the present invention, the pipette element may be an oxide material, e.g., a semiconductor oxide material. For one, this advantageously makes it possible to produce the pipette element as a mechanically especially robust element. For another, it is also advantageous that such a pipette element may be produced in a particularly uncomplicated manner and with the aid of established production steps. Furthermore, due to its media resistance, such a material is particularly suited for the metering of fluids used in biological, medical and/or chemical processes or methods.

According to the present invention, the device may have a multitude of pipette elements, the multitude of pipette elements being disposed in the form of a matrix. This allows a simplification and acceleration of so-called high throughput applications with the aid of the device according to the present invention, thereby making them more cost-effective. In addition, each pipette element may be assigned a heating device, or each individual group of pipette elements may be assigned a heating device shared by this group of pipette elements, or is assigned to a group of heating devices controlled jointly. In this way the individual pipette elements may be actuated selectively and individually, or entire groups of pipette elements may also be actuated jointly for more rapid actuation.

Furthermore, it is particularly advantageous according to the present invention that the heating device is provided as an active heating device, in particular an electrical heating device, or that the heating device is provided as a passive heating device, in particular a heating device actuated by radiation absorption. This achieves an uncomplicated realization of different types of heating devices according to the present invention. In addition, it may be especially advantageous to provide both an active heating device and a passive heating device on one and the same device according to the present invention. This has the advantage that, for example, the active heating device is provided for the general actuation of all pipette elements, and the passive heating device is provided for the selective actuation of individual pipette elements only, or of groups of pipette elements, or vice versa. With regard to an active, in particular an electrically actuated heating device, it is also provided according to the present invention that the electrical contacting be implemented from the same substrate side on which the pipette elements are situated as well.

The present invention also provides a method for producing a device according to the present invention

### BRIEF DESCRIPTION OF THE SEVERAL VIEWS OF THE DRAWING

FIG. 1 shows a first example embodiment of the microfluidic device according to the present invention.

FIG. 2 shows a second example embodiment of the microfluidic device according to the present invention.

FIG. 3 shows a third example embodiment of the microfluidic device according to the present invention.

FIGS. 4 through 7 show various precursor structures to illustrate the production of the first example embodiment of the device according to the present invention.

FIGS. 8 through 12 show various precursor structures to illustrate the production of the second example embodiment of the device according to the present invention.

FIGS. 13 through 16 show various precursor structures to illustrate the production of a variant of the first example embodiment of the device according to the present invention.

FIG. 17 shows a variant of the first example embodiment of the device according to the present invention.

### DETAILED DESCRIPTION OF THE INVENTION

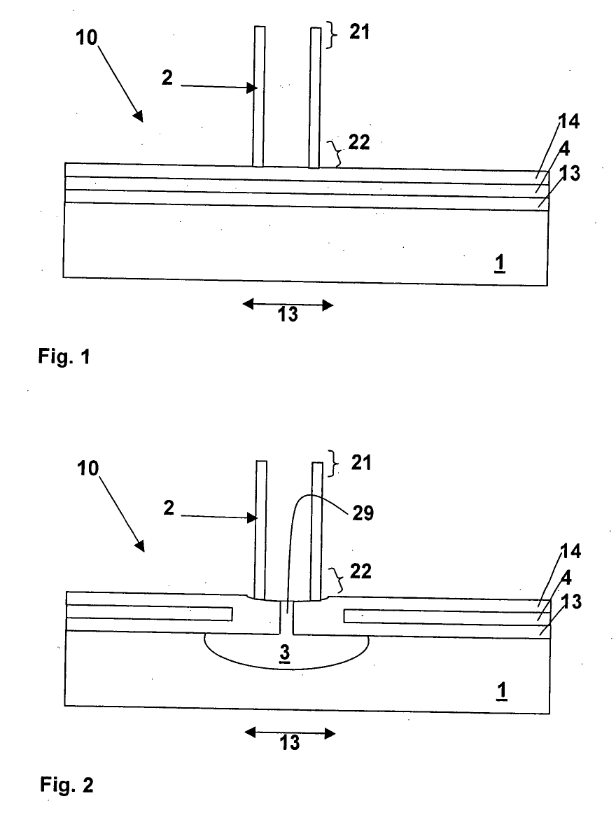

FIG. 1 schematically shows a sectional view of a first example embodiment of a microfluidic device 10 according to the present invention. The device has a pipette element 2, which has a dispensing side 21 and a sealed side 22. Pipette element 2 is also referred to as pipette needle 2 or pipette tip 2 in the following text. To realize a heating device 4, the first specific embodiment provides that a resistance layer 4 be provided between an insulation layer 13, in particular a dielectric insulation layer, and a passivation layer 14, in particular a dielectric passivation layer. Resistance layer 4 is provided with contacts (not shown in FIG. 1) for connection to a voltage source (likewise not shown), so that, when a corresponding electrical voltage is applied, at least localized heating of resistance layer 4 takes place in the region of sealed side 22 of pipette element 2. This heats a fluid present in the interior of the pipette element or a gas present there, and an expansion takes place, which causes a portion of the fluid situated in the region of dispensing side 21 to be expelled from pipette needle 2. According to the first example embodiment, resistance layer 4 is patterned in meander form in the region of sealed side 22 of pipette needle 2, parallel to a main extension plane 13 of substrate 1 extending perpendicular to the drawing plane, in order to achieve the greatest possible heat transfer there.

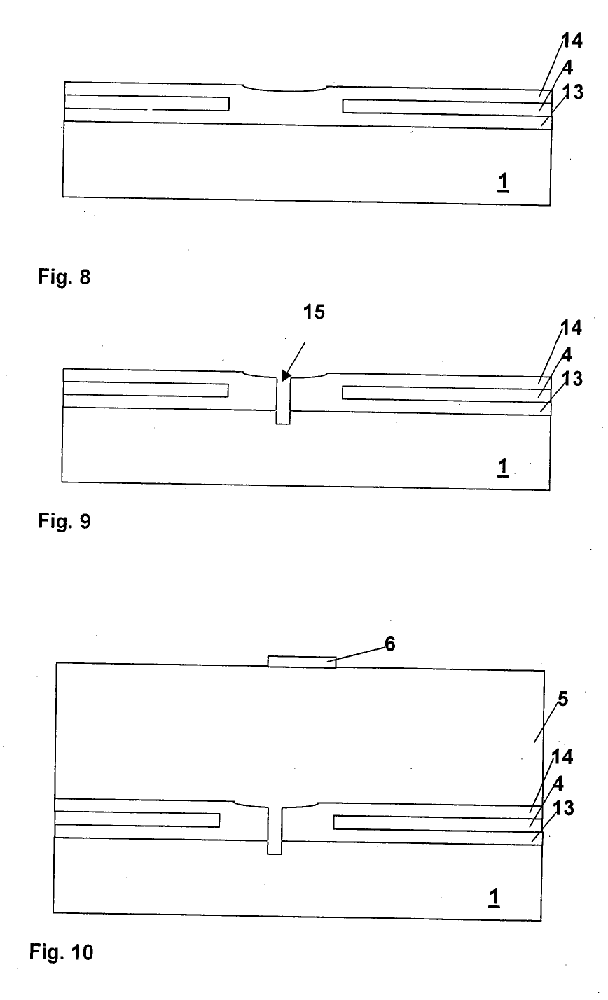

To illustrate the production method of device 10 of the present invention according to the first embodiment, FIGS. 4, 5, 6 and 7 schematically show a sectioned view of, respectively, a first, second, third and fourth precursor structure of the first embodiment of device 10. To produce the first precursor structure (FIG. 4), insulation layer 13 such as a silicon oxide, is first deposited on substrate 1, for instance using a plasma method or by thermal oxidation, the substrate preferably being a silicon substrate. Resistance layer 4 is deposited on insulation layer 13. This may be a metal layer such as platinum, for example, or also a layer from doped silicon or polysilicon. Resistance layer 4 is patterned appropriately in order to allow heating of pipette needle 2. Subsequently, a passivation layer 14, for instance of silicon oxide or silicon nitride, is deposited on the resistance layer. To generate the second precursor structure (FIG. 5), a sacrificial layer 5 is then applied, which preferably is made of deposited polysilicon material. The layer thickness of sacrificial layer 5 later determines the height or length of pipette needle 2. As an option, sacrificial layer 5 may additionally be planarized following its deposition, with the aid of a CMP step (chemical-mechanical polishing). A masking layer 6, which is provided, in particular, in the form of a silicon nitride layer and is patterned in the region of the future pipette needle 2, is deposited on the surface of the sacrificial layer. Via the design of this masking layer 6, it is possible to define the form of the future opening in the tip of the needle. To generate the third precursor structure (FIG. 6), e.g., using an additional photoresist or hard mask, sacrificial layer 5 is removed down to passivation layer 14 with the aid of a trench etching step, so that only future pipette needle 2 remains as (solid) column. Using thermal oxidation, the surface of the solid column of sacrificial layer 5 is coated by an oxide layer, this oxide layer subsequently forming pipette element 2. The thickness of this oxide layer defines wall thickness 25 of pipette needle 2. The surface of pipette needle 2 is protected by masking layer 6 during the oxidation process. To produce the fourth precursor structure (FIG. 7), the masking layer on the surface of pipette needle 2 is selectively removed with respect to the oxide layer, e.g., by a plasma-etching process or by wet chemical etching, which produces an etching access that allows removal of the interior of pipette needle 2, i.e., the rest of sacrificial layer 5 that still remains in the interior. This is done by, in particular, a gas phase etching process such as ClF₃ etching, for example.

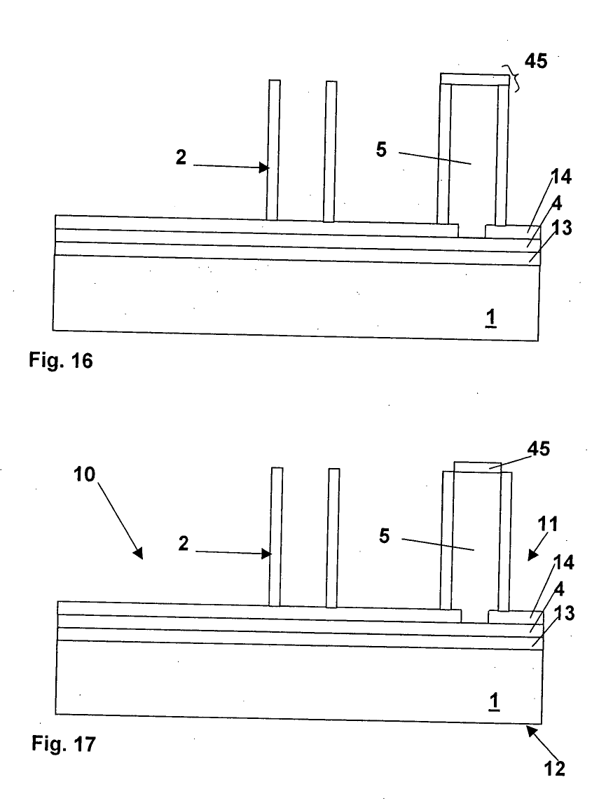

FIG. 17 schematically shows a sectioned view of a variant of the example embodiment of device 10. In contrast to the first embodiment, device 10 has electrical contacting 45 on first side 11 of substrate 1. Reference numerals that are identical to those of the first embodiment (FIG. 1) denote the same elements or components of device 10 in the variant of the first specific embodiment.

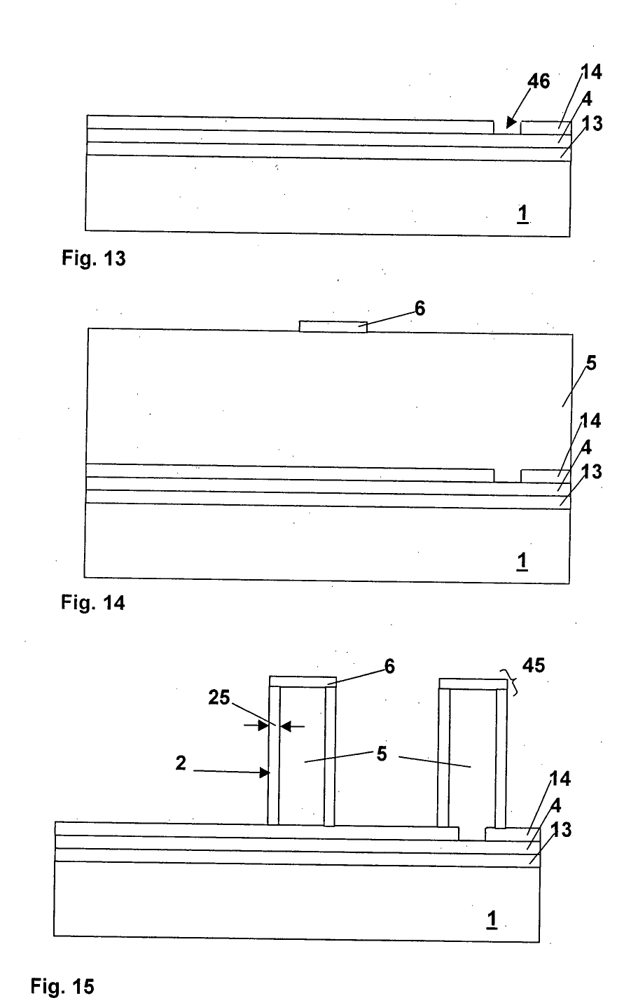

To illustrate the production method of the variant of device 10 of the present invention according to the first example embodiment, FIGS. 13, 14, 15 and 16 schematically show a sectioned view of, respectively, a first, second, third and fourth precursor structure of the variant of the first example embodiment of device 10. To produce the first precursor structure (FIG. 13), insulation layer 13 is first produced on substrate 1, then resistance layer 4 is deposited and patterned, and passivation layer 14 is applied, analogously to the first embodiment. However, to produce future contacting 45 in the variant of the first embodiment, passivation layer 14 is opened up at a location that is denoted by reference numeral 46 in FIG. 13, in particular by a suitable plasma-etching method. To produce the second precursor structure (FIG. 14), sacrificial layer 5 is then applied analogously to the first embodiment; however, it must be doped to produce a corresponding low-impedance connection to resistance layer 4. Analogously to the first embodiment, masking layer 6 is deposited on the surface of sacrificial layer 5, but only in the region of the (future) pipette needle 2. To produce the third precursor structure (FIG. 15), sacrificial layer 5 is removed down to passivation layer 14 (using suitable masking), analogously to the first embodiment, so that both future pipette needle 2 and future contacting 45 remain standing, and oxidized by the thermal oxidation implemented analogously to the first embodiment. Attention must be paid in this context that the layer thickness of this oxidation layer is considerably lower than the layer thickness of passivation layer 14. To produce the fourth precursor structure (FIG. 16), masking layer 6 and then the rest of sacrificial layer 5 remaining in the interior of pipette needle 2 is removed, analogously to the first embodiment; contacting 45 remains largely unchanged in the process. To produce the variant (FIG. 17) of the first embodiment of device 10 according to the present invention, the oxide that remained on the top surface of contacting 45 is removed (e.g., using an anisotropic plasma etching method). Since the layer thickness of passivation layer 14 is greater than that of the oxide on contacting 45, passivation layer 14 is removed only to a slight degree in the process. The doped polysilicon, now exposed, on the surface of contacting 45 may then be locally metalized as contact surface (bond pad) with the aid of a selective metal CVD process (metal chemical vapor deposition process, for instance in the form of a salicide process using wolfram or the like).

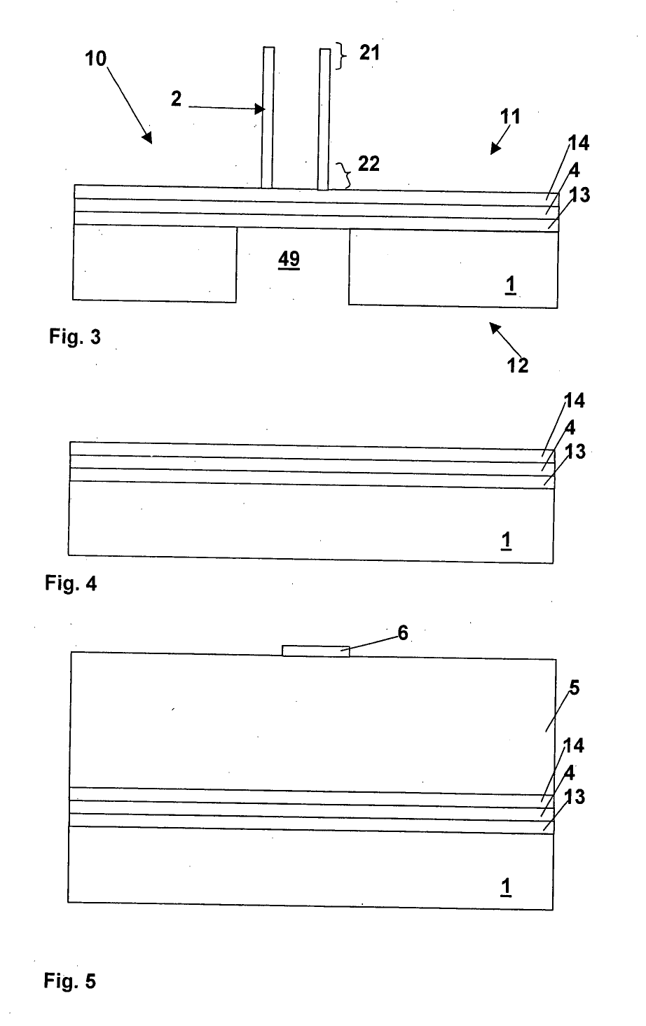

FIG. 2 schematically shows a sectional view of a second example embodiment of microfluidic device 10 according to the present invention. Like the first embodiment, the device has pipette element 2, which has dispensing side 21 and a diametrically opposite side 22, side 22 lying opposite from dispensing side 21 being connected to a reservoir 3. To realize heating device 4, the second embodiment (corresponding to the first specific embodiment) also provides resistance layer 4 between insulation layer 13 and passivation layer 14. Resistance layer 4 is provided with contacts (likewise not shown in FIG. 2) for the connection to a voltage source (also not shown), so that, when a corresponding electrical voltage is applied, at least localized heating of resistance layer 4 takes place in the region of side 2 of pipette element 22 connected to reservoir 3. This heats a fluid present inside the pipette element 2 or inside reservoir 3, or a gas present there, and an expansion takes place, which causes a portion of the fluid located in the region of dispensing side 21 to be expelled from pipette needle 2. The drawing up of the pipette is implemented by the reverse process, i.e., a gas or an expansion fluid already provided in the pipette initially expands due to thermal expansion. Subsequently, the pipette is brought into contact with the fluid to be metered and the heating is then turned off. Due to the negative pressure that is produced, the fluid to be metered will then be taken up into the pipette. According to the second example embodiment, resistance layer 4 is patterned in meander form in the region of sealed side 22 of pipette needle 2, parallel to a main extension plane 13 of substrate 1 extending perpendicular to the drawing plane, or also essentially concentrically around connection passage 29 between the interior of pipette needle 2 and reservoir 3, in order to achieve the greatest possible heat transfer there.

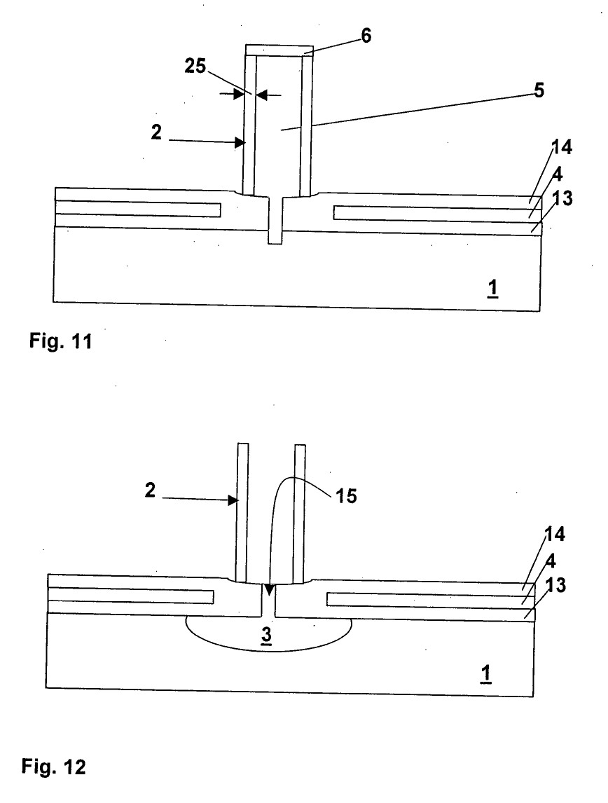

To illustrate the production method of device 10 of the present invention according to the second embodiment, FIGS. 8, 9, 10 and 12 schematically show a sectioned view of, respectively, a first, second, third, fourth and fifth precursor structure of the second embodiment of device 10. To produce the first precursor structure (FIG. 8), insulation layer 13 is first deposited on substrate 1, analogously to the first specific embodiment, resistance layer 4 is deposited and patterned, and passivation layer 14 is applied. Resistance layer 4 is patterned in such a way that it not only allows heating of the bottom of pipette needle 2, but that one region also remains free (of resistance layer 4), so that a subsequent etch access to substrate 1 may be created. To produce the second precursor structure (FIG. 9), this etch access 15 is then created through passivation layer 14 as well as insulation layer 13, in particular by a photolithographic process as well as a subsequent plasma etching step or a wet-chemical etching step. Analogously to the second, third and fourth precursor structures, a third precursor structure (FIG. 10), a fourth precursor structure (FIG. 11), and a fifth precursor structure (FIG. 12) are produced. Analogously to the first embodiment of device 10, the following steps are executed in the process: Sacrificial layer 5 is deposited; masking layer 6 is deposited and patterned; sacrificial layer 5 is removed down to passivation layer 14 with the aid of a trench etching step, so that only future pipette needle 2 remains standing as (solid) column; pipette element 2 is formed as oxide layer by thermal oxidation; masking layer 6 on the surface of pipette needle 2 is removed selectively with respect to the oxide layer, which produces an etch access so that the interior of pipette needle 2 may be removed, in particular with the aid of a gas phase etching process. Due to etch access 15 to substrate 1 implemented so as to form the second precursor structure (FIG. 9) of the second embodiment, not only is the interior of pipette needle 2 removed in the gas phase etching according to the fifth precursor structure of the second embodiment, but reservoir 3 is created as well, i.e., a portion of substrate 1 is removed. The size of reservoir 3 is limited only by the etching time or the thickness of substrate 1.

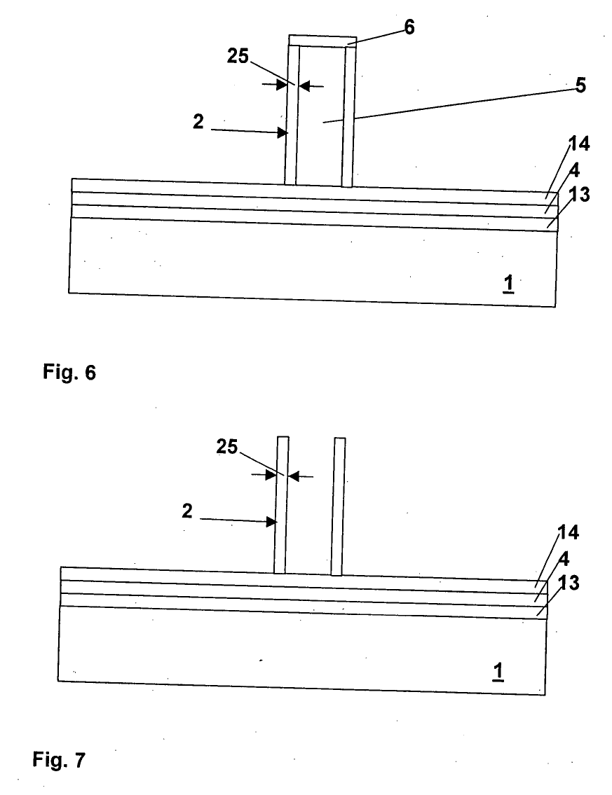

FIG. 3 schematically shows a sectional view of a third example embodiment of microfluidic device 10 according to the present invention. Like in the first and second embodiments of device 10, device 10 has pipette element 2, which has dispensing side 21 and a side 22 lying opposite therefrom. To realize heating device 4, in contrast to the first or second specific embodiments, this third embodiment of device 10 has heating device 4 provided in passive form. This means that (contrary to active heating device 4 according to the first and second embodiments, where heating takes place with the aid of current flow and ohmic resistance) heating device 4 is formed as absorption layer 4 (from polysilicon, for example), which is irradiated with the aid of radiation 49. This may be, for instance, infrared radiation or any other type of radiation. The radiation energy is converted into heat in absorption layer 4 and thereby enables metering of the fluid. The advantage of the third embodiment over the first and second embodiments is that the absorption layer (in contrast to the resistance layer) need not be patterned (but may be patterned). For improved energetic coupling between radiation 49 and absorption layer 4, the third embodiment may provide that an opening be introduced in substrate 1 from second side 12 of substrate 1 (lying opposite from pipette needle 2), in particular with the aid of the process steps of: Photo lithography and subsequent trench etching or also KOH etching. In doing so, substrate 1 is removed, in particular down to insulation layer 13. As an alternative to the adsorption layer, it is also possible to dispose an absorber (not shown) as additional layer in the rear-side opening of the substrate from below.

What is claimed is:

1. A microfluidic device for metering a fluid, comprising:
a substrate;
a heating device disposed above the substrate; and
at least one pipette element disposed above the heating device, wherein the at least one pipette element has a dispensing side and one of: a) a sealed side, wherein the heating device is in the region of the sealed side; and b) a side connected to a reservoir formed in the substrate, wherein the heating device is in the region of the side connected to the reservoir.

2. The microfluidic device as recited in claim 1, wherein the at least one pipette element has a volume of approximately 0.01 picoliter to 1 microliter.

3. The microfluidic device as recited in claim 1, wherein the at least one pipette element has: a) a diameter of approximately 0.5 μm to 500 μm; b) a wall thickness of approximately 10 nanometer to 10 μm.

4. The microfluidic device as recited in claim 3, wherein the at least one pipette element includes a semiconductor oxide material.

5. The microfluidic device as recited in claim 3, wherein a plurality of pipette elements is provided in the form of a matrix.

6. The microfluidic device as recited in claim 5, wherein each of the plurality of pipette elements is assigned a heating device.

7. The microfluidic device as recited in claim 3, wherein the heating device is one of: a) an active heating device including an electrical heating element; and b) a passive heating device utilizing radiation absorption.

8. The microfluidic device as recited in claim 3, further comprising:
an electrical contact for the heating device;
wherein the substrate has a first side and a second side, and wherein the pipette element and the electrical contact of the heating device are provided on the first side of the substrate.

9. A method for producing a microfluidic device including a substrate, a heating device disposed above the substrate, and at least one pipette element disposed above the heating device, wherein the at least one pipette element has a dispensing side and one of: a) a sealed side, wherein the heating device is in the region of the sealed side; and b) a side connected to a reservoir formed in the substrate, wherein the heating device is in the region of the side connected to the reservoir, the method comprising:
applying the heating device one of in and on the substrate and patterning the heating device;
depositing a sacrificial layer above the heating device;
masking, by a masking layer, the sacrificial layer in a region corresponding to a position of the pipette element to be provided;
removing, by a trench etching step, a portion of the sacrificial layer in a surrounding area outside the region corresponding to a position of the pipette element to be provided;
forming the pipette element by an oxidation of a wall area of the sacrificial layer; and
removing, by a gas phase etching step, the sacrificial layer in the interior of the pipette element.

10. The method as recited in claim 9, wherein the reservoir is formed by partial etching of the substrate one of during and following the step of removing the sacrificial layer in the interior of the pipette element.
